(19) United States
(12) Patent Application Publication
(10) Pub. No.: US 2018/0183334 A1
(43) Pub. Date: Jun. 28, 2018

(54) REVERSIBLE ELECTRONIC CIRCUIT-BREAKER TERMINAL

(71) Applicant: PHOENIX CONTACT GMBH & CO. KG, Blomberg (DE)

(72) Inventors: Alexander FOMENKO, Bielefeld (DE); Guido NAHLES, Bad Lippspringe (DE); Carsten PLATTMANN, Paderborn (DE)

(21) Appl. No.: 15/739,218

(22) PCT Filed: Jun. 23, 2016
(86) PCT No.: PCT/EP2016/064498

§ 371 Date: Dec. 22, 2017

(30) Foreign Application Priority Data
Jun. 23, 2015 (DE) 10 2015 211 625.5

(51) Int. Cl. H02M 3/158; H02M 1/08; H02M 1/32; H02H 7/12; H02H 1/00

(52) U.S. Cl. CPC H02M 3/158; H02M 1/08; H02H 1/0007; H02H 7/1213; H02M 1/32

(57) ABSTRACT

The object of the invention is a reversible electronic circuit-breaker terminal, with
a current-measuring device for measuring a current flow in a load circuit to be measured,
a regulating device for controlling the flow of current in the load circuit to be measured on the basis of a measured current flow in the load circuit to be measured,
a switching device which, under the control of the regulating device, regulates or switches the current in the load circuit,
wherein the switching device based on MOS-FET technology and can switch the current bidirectionally in the load circuit, and wherein the switching device has at least two anti-serially connected MOS-FET transistors for this purpose whose respective source terminals lie on a common switching potential.

The invention relates to a reversible electronic circuit-breaker terminal.

Electronic overcurrent circuit breakers for switching and safeguarding direct-current networks are known from the prior art.

For example, electronic circuit breakers for switching and safeguarding a load in direct-current networks (DC networks) are already known. Such circuit breakers generally have a measuring device, a regulating device, a control device, and a switching device that is based on a power transistor.

In the past, N-channel MOSFETs have shown themselves to be effective as switching is devices in low-voltage direct-current networks. Such circuit breakers are capable of switching off the flow of current in the event of a fault (e.g., short circuit) or limiting it to a harmless level.

Such circuit breakers are also sold by the applicant under the product designation CB E1 24DC . . . , EC-E1, for example.

However, the direct-current circuit breakers generally provide only very limited protection from reverse currents, since, due to the N-MOS-FET technology, only a current from drain to source can be switched and/or regulated. There is therefore no protection in the case of a reverse current, which is unsatisfactory.

What is more, the foregoing also results in the drawback that the installation is dependent on the direction of current flow, which can result time and time again in errors during installation.

Electronic overcurrent circuit breakers for switching and safeguarding alternating-current networks are also known from the prior art.

Examples are known from EP application EP 0 197 658 A2 or from EP application EP 0 398 026 A2, for example, which are also based on MOS-FET technology.

However, the circuits are very complicated, and some require an auxiliary voltage supply and are thus very costly. Complicated circuits are also fault-prone.

It is therefore the object of the invention to provide an improved and cost-effective s reversible electronic circuit-breaker terminal that avoids one or more of the drawbacks of the prior art.

The object is achieved according to the invention by the features of the independent claims. Advantageous embodiments of the invention are indicated in the subclaims.

In the following, the invention is explained in further detail with reference to the enclosed drawing on the basis of preferred embodiments.

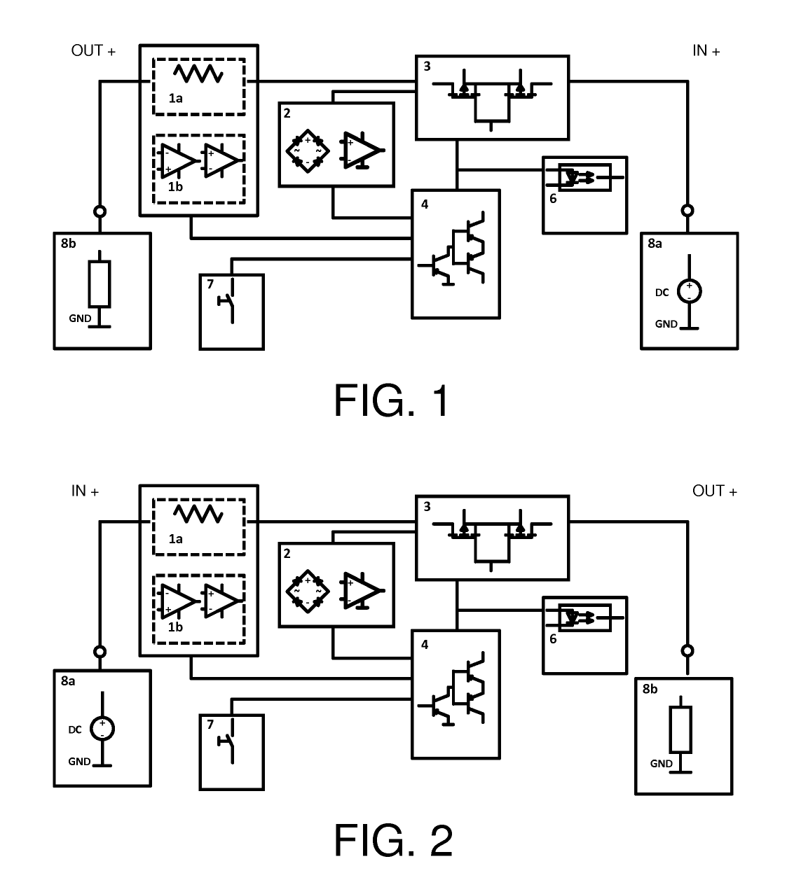

FIG. 1 shows a block diagram of a reversible electronic circuit-breaker terminal according to the invention in accordance with different embodiments in a first configuration, and

FIG. 2 shows a block diagram of the reversible electronic circuit-breaker terminal according to the invention in accordance with different embodiments in a second configuration.

FIGS. 1 and 2 each show a block diagram of a reversible electronic circuit-breaker terminal according to the invention in accordance with different embodiments in two configurations. In the following, reference is made to the figures, with same reference symbols standing for same elements, so that elements that have been described in connection with one figure are not necessarily described again.

According to FIGS. 1 and 2, a reversible electronic circuit-breaker terminal according to the invention has a current-measuring device 1a for measuring a current flow in a load circuit to be measured. The load circuit is formed via the load 8b.

Without limiting generality, any type of current-flow measurement can be used here, such as a drop in voltage via a measuring resistor (as indicated in the figures) or a magnetic field sensor, etc.

Moreover, a reversible electronic circuit-breaker terminal according to the invention has a regulating device 1b for controlling the flow of current in the load circuit 8a, 8b to be measured on the basis of a measured current flow in the load circuit 8a, 8b to be measured. This regulating device can have a controlling effect on the switching device 3 (indirectly via a MOS-FET driver stage 4).

Furthermore, a reversible electronic circuit-breaker terminal according to the invention has a switching device 3 which, under the control of the regulating device 1b, regulates or switches the current in the load circuit 8a, 8b.

“Regulating” can be understood here as the general case of limiting a current flow but also as limiting it to 0 A, i.e., switching it off. The term “regulating” can therefore also include switching.

The switching device 3 of a reversible electronic circuit-breaker terminal according to the invention is based on MOS-FET technology and can switch the current in the load circuit 8a, 8b bidirectionally i.e., independently of whether the current is flowing in the load is direction or in the reverse direction and has at least two anti-serially connected MOS-FET transistors whose respective source terminals lie on a common switching potential.

In FIGS. 1 and 2, the reversible circuit-breaker terminal has the same construction in each case, differing only in the type of external circuitry.

That is, in FIG. 1, the output Out+ and the load 8b are located on the side of the current- measuring device 1a, whereas the input IN+ is located with the voltage source 8a on the side of the switching device 3. In FIG. 2, on the other hand, the input IN+ and the voltage source 8a are located on the side of the current-measuring device 1a, whereas the output Out+ and the load 8b are located on the side of the switching device 3.

That is, with a single device according to the invention, it is now possible to make protection available for forward and reverse currents in relation to the load independently of the installation and thus independently of the direction of current flow, with the device itself being uncomplicated and cost-effective to set up with at least two anti-serially connected MOS-FET transistors whose respective source terminals lie on a common switching potential.

Advantageously, a provision can be made in embodiments of the invention for the switching device 3 to be controlled by means of a MOS-FET driver stage 4. This enables the design effort within the circuit to be minimized, since no technological transition is necessary. What is more, this enables an integrated configuration to be achieved, since both the MOS-FET driver stage 4 and the switching device 3 can be manufactured using the same technology (MOS-FET—metal-oxide-semiconductor field-effect transistor).

More advantageously, a provision can be made in embodiments of the invention for the switching device 3 to have a short-circuit detection unit 2 that is independent of the current direction in the load circuit 8a, 8b and is suitable for controlling the switching device 3 indirectly or directly such that the current in the load circuit 8a, 8b can be regulated or switched off. For example, a partial current can be branched off from the short-circuit detection unit 2 by the switching device 3 and rectified via a (bridge) rectifier and then compared with a reference value, e.g., by means of an operational amplifier or a Schmitt trigger. If the current measured in this manner rises above the preset value, then the current can either be limited to the extent that it remains in a permissible range, or the current is switched off.

For monitoring purposes (either on-site or remotely), a provision can also be made that a (remote) annunciator 6 is furthermore provided which, upon actuation of the switching device 3, signals this operating state. For example, a signal light and/or a remote indication contact can be controlled, with a signaling of both the function and the malfunction being possible here. Of course, it is also possible to use the annunciator for other switching purposes.

What is more, it is especially advantageous for the current-measuring device and/or the regulating device and/or the switching device to be supplied with power from the load circuit, so that no auxiliary voltage supply is needed to operate the reversible electronic circuit-breaker terminal, which reduces wiring complexity and thus the costs of installation as well.

Without limiting generality, the reversible electronic circuit-breaker terminal according to the invention can be used in circuits in which the load circuit is a direct-current circuit or an alternating-current circuit. A (bridge) rectifier can be readily provided for this purpose, for example, which generates direct voltage from any alternating voltage that might be present. This reduces the costs of design and warehousing while simultaneously reducing the likelihood of faulty installation.

It is especially advantageous for the reversible electronic circuit-breaker terminal according to the invention to have a semiconductor-based construction, whereby moving mechanical switching contacts that switch circuits can be avoided. Mechanical switching contacts are subject to wear and are therefore fault-prone.

In addition, a manual actuator 7 can of course also be readily provided as shown in the s figures with which the switching device can be switched on or off (indirectly).

In particular, a reversible electronic circuit-breaker terminal according to the invention permits the current in a load circuit (source->circuit-breaker terminal->load) to be switched and regulated upon occurrence of a short circuit or an overload, with the o purpose of safeguarding the load circuit by switching off the flow of current or limiting it to a level that is harmless to the load circuit. The reversible electronic circuit-breaker terminal according to the invention is particularly advantageous for applications at the low voltage level, particularly with changeable current flow direction.

A reversible electronic circuit-breaker terminal according to the invention is configured such that the load currents are monitored independently of the current flow direction and can be limited or switched off as necessary.

This is achieved by the switching device 3 being equipped with two anti-serially connected power MOSFETs, with the two MOSFET source terminals forming a common point.

The internal measurement and control electronics are designed such that the (DC voltage) current can be measured and regulated independently of the direction of flow. Moreover, the short-circuit detection unit 2 is designed such that a short-circuit condition is identified independently of the direction of flow and the load circuit is shut off. This also prevents the overloading of the MOSFET switching devices 3. The internal electronics can be supplied with (stepped-down and/or rectified) voltage from the load circuit, with it being possible for the reference potential of the voltage to be equal to the reference potential of the load circuit.

Preferably, the reversible electronic circuit-breaker terminal according to the invention is designed for low voltages, i.e., for direct voltages of 24 120 V or alternating voltages of ≥50 V.

Advantageously, the reversible electronic circuit-breaker terminal according to the invention can be designed for a terminal block system, so that it can be integrated into existing terminal block systems feed-through terminals PT . . . QUATTRO, such as those sold by the applicant, for example, with it being especially advantageous that the IN+/OUT+ terminals of the load circuit can each be connected (on one level) to a bridge slot, e.g., by means of the applicant's FBS . . . −5 jumpers. That is, the reversible s electronic circuit-breaker terminal according to the invention can have mounting devices for mounting on a support rail, particularly on a DIN rail. In addition, the reversible electronic circuit-breaker terminal according to the invention can be made available with common grid dimensioning for terminal block systems, such as 6.2 mm width, 5.2 mm width, or less, or greater.

The reversible electronic circuit-breaker terminal also enables a special electromechanical construction if each of the two IN+/OUT+ terminals of the reversible electronic circuit-breaker terminal is connected to a bridge slot (on the left side and right side). The distinctive feature here is that now both bridge slots in the circuit-breaker is terminal reciprocally conduct a separate potential (the unprotected IN+ and the protected OUT+). This enables distribution both of the unprotected IN+ and of the protected OUT+ via the middle bridge slot of the applicant's terminal blocks, thereby rendering the distribution and the schemas for field use especially simple and thus reliable.

By means of the reversible electronic circuit-breaker terminals according to the invention, these can now be used in alternating-voltage applications with changeable current direction, for example. In addition, from the user's perspective, the IN+ and OUT+ lines can be changed out in any desired manner without the need to rotate the reversible electronic circuit-breaker terminals according to the invention. What is more, it is possible to arrange both the unprotected IN+potential and the protected OUT+ potential next to one another on the applicant's already highly distributed terminal blocks.

A cost-effective and reliable solution is thus provided which offers reliable protection in DC applications with reverse currents as well as in AC applications.

### LIST OF REFERENCE SYMBOLS

Current-measuring device 1a

Regulating device 1b

Shut-off device 2

Switching device 3

MOS-FET driver stage 4

Remote annunciator 6

Manual actuator 7

Load circuit, source 8a

Load circuit, load 8b

What is claimed is:

1. A reversible electronic circuit-breaker terminal, with
a current-measuring device (1a) for measuring a current flow in a load circuit to be measured,
a regulating device for controlling the flow of current in the load circuit to be measured on the basis of a measured current flow in the load circuit to be measured,
a switching device which, under the control of the regulating device, regulates or switches the current in the load circuit,
wherein the switching device is based on MOS-FET technology and can switch the current bidirectionally in the load circuit, and wherein the switching device has at least two anti-serially connected MOS-FET transistors for this purpose whose respective source terminals lie on a common switching potential.

2. The reversible electronic circuit-breaker terminal as set forth in claim 1, wherein the switching device is controlled by means of a driver stage.

3. The reversible electronic circuit-breaker terminal as set forth in claim 1, wherein the switching device is controlled by means of a MOS-FET driver stage.

4. The reversible electronic circuit-breaker terminal as set forth in claim 1, wherein the switching device has a short-circuit detection unit that is independent of the current direction in the load circuit and is suitable for controlling the switching device indirectly or directly such that the current in the load circuit can be regulated or switched off.

5. The reversible electronic circuit-breaker terminal as set forth in claim 1, wherein an annunciator is provided which, upon actuation of the switching device, signals this operating state.

6. The reversible electronic circuit-breaker terminal as set forth in claim 1, wherein the current-measuring device and/or the regulating device and/or the switching device is supplied with power from the load circuit.

7. The reversible electronic circuit-breaker terminal as set forth in claim 1, wherein the load circuit is a direct-current circuit.

8. The reversible electronic circuit-breaker terminal as set forth in claim 1, wherein the load circuit is an alternating-current circuit.

9. The reversible electronic circuit-breaker terminal as set forth in claim 1, further comprising a remote annunciator.
